(19) United States
(12) Patent Application Publication
(10) Pub. No.: US 2013/0189791 A1
(43) Pub. Date: Jul. 25, 2013

(54) Methods for Measuring Formaldehyde Emission From One or More Samples

(71) Applicant: Georgia-Pacific Chemicals LLC, Atlanta, GA (US)

(72) Inventor: Alan Andres Phillips, Albany, OR (US)

(73) Assignee: GEORGIA-PACIFIC CHEMICALS LLC, Atlanta, GA (US)

(21) Appl. No.: 13/744,846

(22) Filed: Jan. 18, 2013

Related U.S. Application Data
(60) Provisional application No. 61/589,117, filed on Jan. 20, 2012.

(51) Int. Cl. G01N 27/416

(52) U.S. Cl. CPC G01N 27/4162
USPC 436/130

(57) ABSTRACT

Methods for measuring formaldehyde emissions from a plurality of samples. An electrochemical sensor can be calibrated using a reference sample to provide a calibrated electrochemical sensor, where the time of calibration is equal to time zero. A plurality of samples can be placed within a sample chamber one at a time and a formaldehyde concentration of a gas passed across one or more surfaces of each sample can be measured. The first sample measured can be measured again as the last sample. A linear regression trend-line based on the two formaldehyde concentrations measured from the first sample can be generated. A revised linear regression trend-line based on what the formaldehyde concentration of the first sample would be at time zero and the formaldehyde concentration of the first sample when re-measured as the last sample can be generated. A correction factor for at least one of the plurality of samples measured between the two measurements of the first sample can be generated. The measured formaldehyde emission for the at least one of the plurality of samples measured between the two measurements of the first sample can be multiplied by its correction factor to provide a corrected formaldehyde concentration for the at least one of the plurality of samples.

### CROSS-REFERENCE TO RELATED APPLICATION

This application claims priority to U.S. Provisional Patent Application having Ser. No. 61/589,117, filed on Jan. 20, 2012, which is incorporated by reference herein.

### BACKGROUND

1. Field

Embodiments described herein generally relate to methods for measuring formaldehyde emission from one or more samples. More particularly, such embodiments relate to methods for correcting a formaldehyde sensor signal response obtained while measuring formaldehyde emission from one or more samples.

2. Description of the Related Art

Products, e.g., composite wood products, made with resins containing formaldehyde can continue to off-gas formaldehyde therefrom for years after the product is made, which may need to be monitored in certain applications, e.g., home construction. As such, various standards, such as those promulgated by the California Air Resources Board (CARB) and the Formaldehyde Standards for Composite Wood Products Act, have been established defining the permissible maximum level of formaldehyde emission from composite wood products.

A variety of methods have been developed to measure formaldehyde emissions from materials such as composite wood products. The formaldehyde testing methods fall into two main categories: full scale tests, which are designed to give results comparable to the environment encountered in actual use, and lab tests, which are designed to mimic the results obtained using the full scale test.

One challenge with the detection of formaldehyde from composite products typically made with formaldehyde based resins is that the level of formaldehyde emission is extremely low. Depending on the particular composite product, the standards can require that formaldehyde emission therefrom be less than 0.13 ppm or even less than 0.04 ppm. At these low levels of formaldehyde emission error in the formaldehyde measurements can have an impact on quality control. For example, if the formaldehyde emission results are lower than the actual value, composite products that exceed the necessary formaldehyde emissions standard could be mistakenly considered acceptable.

There is a need, therefore, for improved methods for measuring formaldehyde emission from products.

### SUMMARY

Methods for measuring formaldehyde emissions from a plurality of samples are provided. In at least one specific embodiment, the method can include calibrating an electrochemical sensor using a reference sample to provide a calibrated electrochemical sensor, where the time of calibration is equal to time zero. A plurality of samples can be placed within a sample chamber one at a time and a formaldehyde concentration of a gas passed across one or more surfaces of each sample can be measured. The first sample measured can be measured again as the last sample. A linear regression trend-line based on the two formaldehyde concentrations measured from the first sample can be generated. A revised linear regression trend-line based on what the formaldehyde concentration of the first sample would be at time zero and the formaldehyde concentration of the first sample when re-measured as the last sample can be generated. A correction factor for at least one of the plurality of samples measured between the two measurements of the first sample can be generated. The measured formaldehyde emission for the at least one of the plurality of samples measured between the two measurements of the first sample can be multiplied by its correction factor to provide a corrected formaldehyde concentration for the at least one of the plurality of samples.

In at least one specific embodiment, the method for measuring formaldehyde emissions from one or more wood samples made can include calibrating an electrochemical sensor using a reference sample to provide a calibrated electrochemical sensor, where the time of calibration is equal to time zero. A plurality of wood based samples can be placed within a sample chamber one at a time and a formaldehyde concentration of a gas passed across one or more surfaces of each wood based sample can be measured. The first wood based sample measured can be measured again as the last sample. Measuring the formaldehyde concentration of each sample can include flowing the gas through the sample chamber when each wood based sample is located therein to produce the formaldehyde containing gas. At least a portion of the formaldehyde containing gas can be contacted with a sensing electrode of the electrochemical sensor. A current generated by the sensing electrode when in contact with the formaldehyde containing gas can be detected. The detected current can be correlated to a formaldehyde concentration. A linear regression trend-line can be generated, where the linear regression trend-line is based on at least two points. The first point can be equal to the formaldehyde concentration of the first wood based sample measured after calibration of the electrochemical sensor, and the second point can be equal to the formaldehyde concentration of the first wood based sample when measured again as the last sample. A formaldehyde emission for the first wood based sample at time equal to time zero can be determined. A revised linear regression trend-line based on at least two points can be generated. The first point can be equal to the formaldehyde concentration of the first wood based sample at time zero and the second point can be equal to the formaldehyde concentration of the first wood based sample when measured again as the last sample. A correction factor for at least one of the plurality of wood based samples can be determined. The correction factor for the at least one of the plurality of wood based samples can be equal to the formaldehyde concentration of the first wood based sample at time zero divided by what the concentration of the first wood based sample would be at the time the at least one of the plurality of wood based samples was measured. The measured formaldehyde concentration of the at least one of the plurality of wood based samples can be multiplied by its correction factor to provide a corrected formaldehyde concentration value for the at least one of the plurality of samples.

In at least one specific embodiment, the method for measuring formaldehyde emissions from a plurality of samples that emit formaldehyde therefrom can include calibrating an electrochemical sensor using a reference sample to provide a calibrated electrochemical sensor. The time of calibration can be equal to time zero and calibrating the electrochemical sensor can include measuring a formaldehyde concentration of a gas passed across one or more surfaces of the reference sample while within a sample chamber. A plurality of samples can be placed within the sample chamber one at a time and a formaldehyde concentration of a gas passed across one or more surfaces of each sample can be measured. A linear regression trend-line based on two or more of the measured formaldehyde concentrations can be generated. A correction factor for at least one of the plurality of samples can be generated. The measured formaldehyde concentration for the at least one of the plurality of samples measured can be multiplied by its correction factor to provide a corrected formaldehyde concentration for the at least one of the plurality of samples.

### BRIEF DESCRIPTION OF THE DRAWINGS

FIG. 1 depicts a graphical representation of a linear regression trend-line of formaldehyde emission from production samples 1-5 measured according to one or more embodiments discussed and described herein.

FIG. 2 depicts a graphical representation of a revised linear regression trend-line of formaldehyde emission from production samples 1-5 that represents the corrected formaldehyde emission of production sample 1 for time zero, where time zero is the time at which the electrochemical sensor was calibrated.

FIG. 3 depicts a graphical representation of a measured formaldehyde concentration emitted from a single sample that was measured ten times in each of three separate sets of measurements.

FIG. 4 depicts an illustrative electrochemical sensor, according to one or more embodiments described.

FIG. 5 depicts an exploded view of a sensing cell depicted in FIG. 4, according to one or more embodiments described.

FIGS. 6 and 7 depict a side and top view, respectively, of an illustrative sample chamber, according to one or more embodiments described.

FIG. 8 depicts an illustrative formaldehyde measurement system, according to one or more embodiments described.

FIG. 9 depicts a representative computer system that can be used to correct one or more formaldehyde emission measurements, according to one or more embodiments described.

### DETAILED DESCRIPTION

Electrochemical sensors operate by passing gas molecules containing the targeted compound from a source or sample, e.g., a formaldehyde containing gas emitted from a composite wood product made with an adhesive containing formaldehyde, through a diffusion medium, and adsorbing the gas molecules on an electrocatalytic sensing electrode maintained at a bias or sensing potential appropriate for the electrode. The adsorbed gas molecules react and generate an electric current proportional in magnitude to the concentration of the targeted compound, which can be indicated by a meter connected to an output of the electrochemical sensor or an amplifier that amplifies the current from the electrochemical sensor.

The electrochemical sensor can incorporate two electrodes in contact with an electrolyte. The first electrode can be referred to as a “sensing electrode” and the second electrode can be referred to as a “counterelectrode.” When the gas containing the targeted compound contacts the sensing electrode, reactions occur that cause a current to flow in a circuit that includes the counterelectrode, the electrolyte, the sensing electrode and an external lead connecting the sensing electrode back to the counterelectrode. The magnitude of this current is proportional to the concentration of the targeted compound in the gas. By appropriate selection of the counterelectrode and the electrolyte, the sensing cell may be made selective to a particular targeted compound or gas species. The targeted compound can be or include, but is not limited to, formaldehyde, one or more nitrogen oxides, and sulfur dioxide. For simplicity and ease of description, the targeted compound will be further discussed and described as being formaldehyde gas emitted from a source or sample, e.g., a composite wood product made with a formaldehyde containing adhesive.

Depending on the target compound to be detected, either oxidation or reduction occurs at the sensing electrode, and the complementary reaction occurs at the counterelectrode. For example, to detect formaldehyde (CH₂O), oxidation occurs at the sensing electrode, which preferably includes a noble metal such as gold. Electrochemical reduction occurs at the counterelectrode, which can include lead in an electrolyte of aqueous potassium hydroxide.

A preferred sensor construction can include an external voltage bias to maintain a constant potential on the sensing electrode relative to a nonpolarizable reference counterelectrode. The term “non-polarizable” refers to a counterelectrode that can sustain a current flow without suffering a change in potential. Such nonpolarizable counter-electrodes avoid the need for a third electrode and a feedback circuit. Because the oxidation and reduction potential for formaldehyde is known or readily determinable by routine experimentation, the bias may be set to ensure that substantially only formaldehyde reacts at the sensing electrode. The operating bias can range from about 30 mV to about 300 mV. A suitable electrochemical sensor for measuring the concentration of formaldehyde and/or other target compounds can be the INTERSCAN® Model GP-116 formaldehyde sensor, which is available from Georgia-Pacific Chemicals LLC. A suitable electrochemical sensor is also discussed and described in U.S. Pat. No. 4,017,373.

It has unexpectedly been discovered that the electrochemical gas sensor does not accurately measure the concentration of formaldehyde in a gas containing formaldehyde over time. Instead, it has been found that the concentration of formaldehyde measured by the electrochemical gas sensor drifts over time with the measured concentration being lower than the actual concentration of the sample being measured. It has also been discovered that, over the initial 2.5 to 3.5 hours of operation, the electrochemical sensor drift is linear. It has further been unexpectedly discovered that about 2.5 to about 3.5 hours after calibration of the electrochemical sensor, the sensor's rate of drift decreases or slows as compared to the sensor's rate of drift over initial 2.5 to about 3.5 hours of operation immediately following calibration of the electrochemical sensor.

The electrochemical sensor can be used to detect the concentration of formaldehyde emitted from a sample located within a sample chamber. The sample chamber can be part of a Dynamic Micro-Chamber available from Georgia-Pacific Chemicals LLC, which will be further discussed and described in more detail below. The electrochemical sensor can be in fluid communication with the sample chamber such that the sensing electrode can be contacted with at least a portion of a formaldehyde containing gas flowing from the sample chamber.

Prior to testing a sample or a plurality of samples (e.g., a plurality of from about 2 to about 10 different samples can be separately tested over a period of time, e.g., about 2 to about 4 hours) that emit(s) an unknown amount of formaldehyde, the electrochemical sensor can be calibrated to provide a calibrated sensor. Calibration of the electrochemical sensor can include placing reference or calibration sample within the sample chamber that emit(s) a known amount of formaldehyde and allowing the reference sample to reach equilibrium with respect to the rate of formaldehyde emission therefrom. The amount of formaldehyde emitted from the reference sample can be quantified through conventional wet chemistry techniques according to ASTM E1333-10 and ASTM D6007-02 (2008). The amount of formaldehyde measured or detected from the reference sample can be used to calibrate the electrochemical sensor.

The reference sample as well as the one or more samples to be measured for an amount of formaldehyde emitted therefrom can be conditioned prior to testing. For example, the reference sample can be conditioned within the sample chamber and the one or more samples can be conditioned in a conditioning cabinet. The reference sample and/or the samples to be measured can be any material that emits or potentially emits formaldehyde and/or one or more other compounds to be measured. For example, the reference sample and/or the samples to be measured can be a solid piece of wood or other lignocellulosic containing material. In another example, the reference sample and/or the samples to be measured can be composite products containing formaldehyde. Illustrative solid wood products or samples can include, but are not limited to, lumber, paneling, other items formed, e.g., carved, machined, milled, and/or cut from wood, wood in its natural state, i.e., non-processed or unmodified wood, and the like. Illustrative composite products or samples can include, but are not limited to, particleboard, medium density fiberboard, high density fiberboard, oriented strand board, plywood, laminated veneer lumber, fiberglass mats, fiberglass insulation, ceiling tiles, and the like, made with one or more adhesives containing formaldehyde. Other composite products that can emit formaldehyde can include non-wood containing or non-wood based products. Such non-wood based products can include, but are not limited to, fiberglass insulation, fiberglass mats, gypsum wall board, carpet backing, roofing shingles, roving, micro-glass based substrates such as those for printed circuit boards, battery separators, filter stock, tape stock, paper products, and the like. Other composite products can include laminates such as high pressure laminates. One exemplary high pressure laminate can include FORMICA® Laminate.

Since each sample in a plurality of samples can be measured separately with respect to one another over a period of time, the samples in the plurality of samples can be the same or different type of sample with respect to one another. For example, each sample of the plurality of samples can be the same type of sample, e.g., a plywood sample or a solid wood sample, with respect to one another. In another example, at least two samples of the plurality of samples to be measured can be a different type of sample with respect to one another. For example, at least one sample can be a medium density fiberboard and at least one sample can be a plywood sample.

The edges of the product or sample, and particularly the edges of particleboard and MDF, generally have a much higher formaldehyde diffusion (emission) rate than the surfaces of the board. The edges also constitute a proportionately greater fraction of the total surface area of the board sample in the smaller sized samples used in connection with the apparatus and methods discussed and described herein than in the full sized composite wood panels from which they can be prepared from. As such, to obtain an accurate measurement of the formaldehyde emission of composite products from which the samples can be obtained, the edges of the samples can be sealed to prevent or retard formaldehyde emission during testing to avoid bias. Suitable sealing materials preferably include nonporous tapes and possibly non-volatile liquid sealants. For example, aluminum tape and/or wax can be used to seal the edges of a composite sample.

Conditioning the samples can include flowing a gas across one or more surfaces of the samples for a period of time. Suitable gases can include, but are not limited to, air, nitrogen, carbon dioxide, argon, oxygen, or any combination thereof. The gas can be passed across the one or more surfaces of the samples at a rate or velocity ranging from a low of about 0.1 meters per minute (“m/min”), about 0.218 m/min, or about 0.227 m/min, about 0.5 m/min, about 1 m/min, about 3 m/min, or about 5 m/min to a high of about 20 m/min, 45 m/min, about 60 m/min, or 75 m/min, or about 100 m/min. For example, a preferred rate or velocity of the gas can range from about 42 m/min to about 49 m/min such as about 45.5 m/min.

The samples can be conditioned for a time of about 1 hour or more, about 1.5 hours or more, about 2 hours or more, about 2.5 hours or more, about 3 hours or more, or about 4 hours or more. Preferably, the samples are conditioned for a time period of at least 2 hours prior to locating the sample in the sample chamber for measurement thereof. The samples can be conditioned within a conditioning cabinet, a conditioning room, or within the sample chamber prior to testing.

After the samples have been conditioned one or more of the samples, e.g., a plurality of samples, can be located or placed one at a time within the sample chamber and a concentration of formaldehyde emitted therefrom can be measured. A gas can be introduced to the sample chamber and can flow across one or more surfaces of the sample to produce a formaldehyde containing gas. Suitable gases can include, but are not limited to, air, nitrogen, carbon dioxide, argon, oxygen, or any combination thereof. The gas can be introduced to the sample chamber at a rate ranging from a low of about 0.1 liter per minute (“l/min”), about 0.218 l/min, or about 0.227 l/min to a high of about 20 l/min, about 50 l/min, about 100 l/min, about 200 l/min, about 300 l/min, about 400 l/min, about 438 l/min, about 454 l/min, about 500 l/min, or about 600 l/min. For example, the gas can be introduced to the sample chamber at a flow rate ranging from about 0.01 l/min, about 0.1 l/min, about 1 l/min, about 2 l/min, about 4 l/min, about 6 l/min or about 8 l/min to a high of about 10 l/min, about 12 l/min, about 14 l/min, about 16 l/min, about 18 l/min, or about 20 l/min, when the sample chamber has a volume ranging from about 0.04 m³ to about 0.05 m³.

The conditioning and testing conditions can be carried out at a temperature ranging from a low of about 19.5° C., about 21° C., or about 23° C. to a high of about 27° C., about 29° C., or about 30.5° C. and at a relative humidity ranging from a low of about 40%, about 43%, about 45%, or about 48% to a high of about 52%, about 55%, about 57%, or about 60%. If a dry gas such as nitrogen is used moisture can be added to the nitrogen to provide a nitrogen gas having a relative humidity ranging from about 40% to about 60%.

The background formaldehyde, i.e., the formaldehyde present in the environment surrounding the sample chamber and the air or other gas that can be directed into the sample chamber can have background formaldehyde concentration of less than about 0.1 ppm, less than about 0.07 ppm, less than about 0.05 ppm, less than about 0.04 ppm, less than about 0.03 ppm, less than about 0.02 ppm, or less than about 0.01 ppm, as measured according to a 60 minute gas test using an impinger. The 60 minute gas test can be as discussed and described in ASTM E1333-10 and ASTM D6007-02 (2008).

Once the electrochemical sensor is calibrated with the reference sample, the electrochemical sensor can be used for up to about 2.5 to about 3.5 hours, e.g., about 3 hours, before recalibration of the electrochemical sensor may be required. Measurement of the formaldehyde emission from each sample(s) can be completed in a time frame ranging from about 10 minutes to about 20 minutes, about 12 minutes to about 18 minutes, or about 14 minutes to about 16 minutes. For example, measurement of the formaldehyde emission from each sample can be completed in a time frame of about 15 minutes. The number of samples measured in a time period of about 2.5 to about 3.5 hours that can be available for testing after calibration of the electrochemical sensor against the reference sample can range from about 1 to about 20 samples, e.g., about 9 to about 12.

Testing a plurality of samples, e.g., about 2 to about 11 samples, for a time period up to about 2.5 to about 3.5 hours after calibration can be conducted in a number of ways. For example, a first method for testing a group or plurality of samples can include measuring a first sample followed by 1 to about 10 other samples and then the first sample can be measured again as the last sample in that group. In another example, a second method can include measuring a plurality of samples, e.g., about 2 to about 11 samples, followed by measuring the reference sample used to calibrate the electrochemical sensor as the last sample in that group.

In the first method, a linear regression trend-line and formula can be generated using the concentration of the formaldehyde measured by the electrochemical sensor and the time at which the measurement was taken for the two measurements of the first sample. The formula of the linear regression trend-line can be in the form of a straight line equation, i.e., y=mx+b, where m is equal to the slope of the linear regression trend-line, x is equal to time, and b is equal to the y-intercept of the linear regression trend-line (when x is zero). If desired, the formaldehyde emission of the first sample can be measured one or more additional times between the first and last measurement, and the linear regression trend-line and formula can be based on the three or more additional measurements of the first sample. As such, the linear regression trend-line can be based on a two point measurement, a three point measurement, a four point measurement, or more. It has been found that measuring the formaldehyde emission of the first sample again as the last sample and generating the linear regression trend-line based on those two measurements alone yields accurate results.

It has also been found that the formaldehyde emission measured by the electrochemical sensor begins to drift immediately after the electrochemical sensor has been calibrated. As such, accounting for the electrochemical sensor drift that can take place between calibration of the electrochemical sensor and measurement of the first sample can include determining the formaldehyde concentration emitted at time zero for the first measurement of the first sample. “Time zero” is the time at which the calibration of the electrochemical sensor was performed, i.e., when the concentration of formaldehyde emitted from the reference sample that emitted a known amount of formaldehyde was measured. Time zero can be the time at the start of the calibration measurement, the time at the end of the calibration measurement, or the time at any point between the start of the calibration measurement and the end of the calibration measurement.

To determine the amount of formaldehyde emitted from the first production sample at time zero, the time at which the first sample was measured can be multiplied by the slope of the linear regression trend-line and this product can be added to the y intercept (b). The time can be represented as a fraction of the day. For example, the time 12:57:47 would be represented as 0.5401273, which is equal to (((12 hours×60 minutes)+57 minutes+(47 seconds/60 seconds))/1440 minutes). To determine the correct amount of formaldehyde emitted from the samples measured between the first and last measurements, the measured values can be multiplied by a correction factor. The correction factor is equal to the formaldehyde emission of the first sample at time zero divided by what the formaldehyde emission of the first sample would have been measured as at the time the second, third, fourth, etc. samples was measured.

The second method can include generating a linear regression trend-line similar to the first method. Rather than using the first production sample (measured first and again as the last sample), however, the linear regression trend-line can be generated using the formaldehyde concentration of the calibration sample measured at time zero and again as the last sample. In another example, the linear regression trend-line can be generated using the formaldehyde concentration of the calibration sample measured at time zero and the formaldehyde concentration of one or more of the plurality of samples. In yet another example, the linear regression trend-line can be generated using the formaldehyde concentrations of at least two of the plurality of samples. As discussed and described in more detail below, the electrochemical sensor can be coupled to or otherwise in communication with a computer and/or other system(s) and/or device(s) capable of automatically calculating the linear regression trend-line, the correction factor, the corrected formaldehyde emission values, and the like.

### EXAMPLE

In order to provide a better understanding of the foregoing discussion, the following non-limiting examples are offered. Although the examples may be directed to specific embodiments, they are not to be viewed as limiting the invention in any specific respect.

### Example I

For simplicity and ease of description, the first method of measuring a plurality of production samples, i.e., five, will be discussed and described in more detail. The tests were conducted in a GP™ Dynamic Microchamber (DMC) that used an INTERSCAN® electrochemical sensor Model GP-116. Each sample includes three composite boards having a dimension of about 20 cm×about 38.1 cm. The edges of each board were sealed with aluminum tape. The boards were loaded into the sample chamber, as shown in FIG. 5, which is discussed and described below. The samples were conditioned in a conditioning cabinet for about 2 hours prior to testing with air flowing across the surfaces at a rate of about 45.7 m/min. The temperature within the sample chamber was about 25° C. and the relative humidity was about 50%. The electrochemical sensor was calibrated at 12:57:47 PM by using a reference sample emitting a known amount of formaldehyde.

Table 1 below shows the time and concentration of formaldehyde in ppm for five production samples and the time at which each sample was measured. Prior to measuring Sample 1, a reference sample was used to calibrate the electrochemical sensor. The reference sample emitted a known amount of formaldehyde, which was determined using known wet chemistry techniques according to ASTM E1333-10. Prior to measuring the sample (the reference sample and Samples 1-5), each sample was conditioned for about 2 hours. The samples were conditioned by flowing air at a rate of about 70.8 Us across the samples, at a temperature from about 23.9° C. to about 25° C., a relative humidity of about 48% to about 52%, and with less than 0.04 ppm background formaldehyde. The reference sample was conditioned within the sample chamber and Samples 1-5 were conditioned within a conditioning cabinet. Each of Samples 1-5 were allowed to equilibrate within the sample chamber for about 5 minutes prior measuring the formaldehyde emission therefrom.

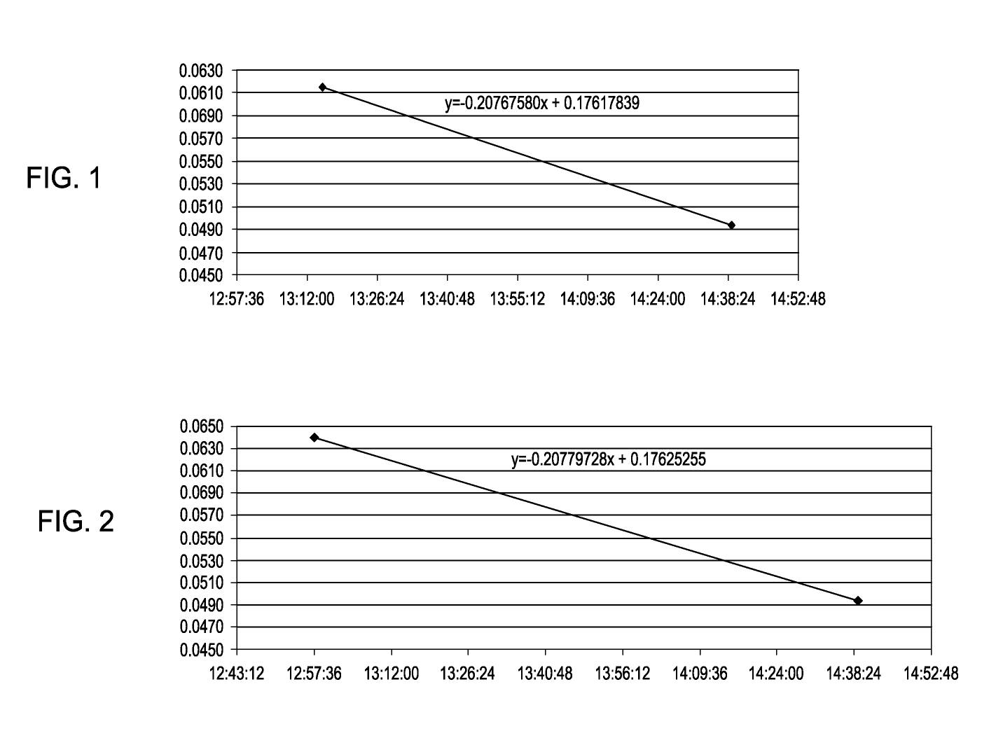

As shown in FIG. 1, a two point linear regression trend-line and formula was generated using the first and last measured samples. The last sample measured (Sample 1) was the same sample that was measured first (Sample 1) after calibration of the electrochemical sensor. As shown in Table 1, the concentration of formaldehyde decreased over the time period the samples were measured. More particularly, the amount of formaldehyde measured for Sample 1 at 13:15:10 was 0.0615 ppm, but when Sample 1 was measured again at 14:39:04 the measured formaldehyde had decreased to 0.0494 ppm. These two measured values should have been the same, but due to the drift in the electrochemical sensor, the second measurement of Sample 1 shows a decrease in emitted formaldehyde.

A two point linear regression trend-line was generated using the first formaldehyde emission measurement (Sample 1 measured at 13:15:10) and the last formaldehyde emission measurement (Sample 1 at 14:39:04). FIG. 1 depicts a graphical representation of the linear regression trend-line of formaldehyde emission from production Samples 1-5 measured. As shown in FIG. 1, the linear regression trend-line had the formula: y=−0.20767580x+0.17617839.

TABLE 1

| | | Measured |
|---|---|---|
| | | Formaldehyde |
| | | Concentration |
| Sample | Time | (ppm) |
| 1 | 13:15:10 | 0.0615 |
| 2 | 13:33:31 | 0.1197 |
| 3 | 13:49:35 | 0.1178 |
| 4 | 14:05:32 | 0.1365 |
| 5 | 14:22:06 | 0.1412 |
| 1 | 14:39:04 | 0.0494 |

As noted above, the electrochemical sensor was actually calibrated at 12:57:36. As such, the formaldehyde emission for the first production sample (Sample 1) measured at 13:15:10 needed to be determined for time zero, i.e., 12:57:35. The formaldehyde emission value (y) at time zero equals ((−0.20767580×0.5401273)+0.17617839), which is equal to 0.640 ppm. Accordingly, Table 1 above should be revised to represent the formaldehyde emission of the first production sample (Sample 1) measured after calibration of the electrochemical sensor at time zero.

TABLE 2

| | | Measured |
|---|---|---|
| | | Formaldehyde |
| | | Concentration |
| Sample | Time | (ppm) |
| 1 | 12:57:47 | 0.0640 |
| 2 | 13:33:31 | 0.1197 |
| 3 | 13:49:35 | 0.1178 |
| 4 | 14:05:32 | 0.1365 |
| 5 | 14:22:06 | 0.1412 |
| 1 | 14:39:04 | 0.0494 |

As such, the true value of the first production sample (Sample 1) for time zero was determined and a second linear regression trend line was generated to determine the correction factor for Samples 2-5. FIG. 2 depicts the graphical representation of the revised linear regression trend-line of formaldehyde emission from production samples 1-5 that represent the corrected formaldehyde emission of production sample 1 for time zero, where time zero was the time at which the electrochemical sensor was calibrated. As shown in FIG. 2, the revised linear regression trend-line was y=−0.20779728x+0.17625255.

As discussed above, the correction factor for Samples 2-5 will be the formaldehyde emission for Sample 1 at time zero divided by what the formaldehyde emission of the first sample would be at the time each of Samples 2-5 were measured. For example, as shown in Tables 1 and 2 above, Sample 2 was measured at 13:33:31. The time 13:33:31 is equal to 0.5649421 when represented as a fraction of a day. As such, Sample 1 would have a formaldehyde concentration at 13:33:31 equal to (−0.02779728*0.5649421)+0.17625255=0.0589. Accordingly, the correct formaldehyde emission value for Sample 2 would be equal to the measured emission value (0.1197) times the correction factor (0.0640/0.0589), which is equal to 0.1302 ppm.

Table 3 below shows the measured formaldehyde emission, the formaldehyde emission for the first sample at the time each of Samples 2-5 was measured, the corrected formaldehyde emission value for the first sample at the subsequent measurement times of Samples 2-5, the correction factor for each of Samples 2-5, and the corrected formaldehyde emission value for Samples 2-5.

TABLE 3

| | | | Formaldehyde | | |
|---|---|---|---|---|---|
| | | | Concentration | | |
| | | | for Sample 1 | | Corrected |
| | | Measured | at each | | Formaldehyde |
| | | Formaldehyde | Subsequent | | Emission for each |
| | | Concentration | Measurement | Correction | Production |
| Sample | Time | (ppm) | (ppm) | Factor | Sample (ppm) |
| 1 | 12:57:47 | 0.064 | 0.064 | 1 | 0.064 |
| 2 | 13:33:31 | 0.1197 | 0.0589 | 1.088 | 0.1302 |
| 3 | 13:49:35 | 0.1178 | 0.0565 | 1.132 | 0.1334 |
| 4 | 14:05:32 | 0.1365 | 0.0542 | 1.18 | 0.1611 |
| 5 | 14:22:06 | 0.1412 | 0.0518 | 1.235 | 0.1743 |
| 1 | 14:39:04 | 0.0494 | 0.0494 | 1.296 | 0.064 |

As shown in Example I, drift in the electrochemical sensor encountered during measurement of the 5 samples can be accounted for to provide reliable and accurate formaldehyde emission values for the 5 samples in a very short amount of time as compared to conventional large scale tests.

### Example II

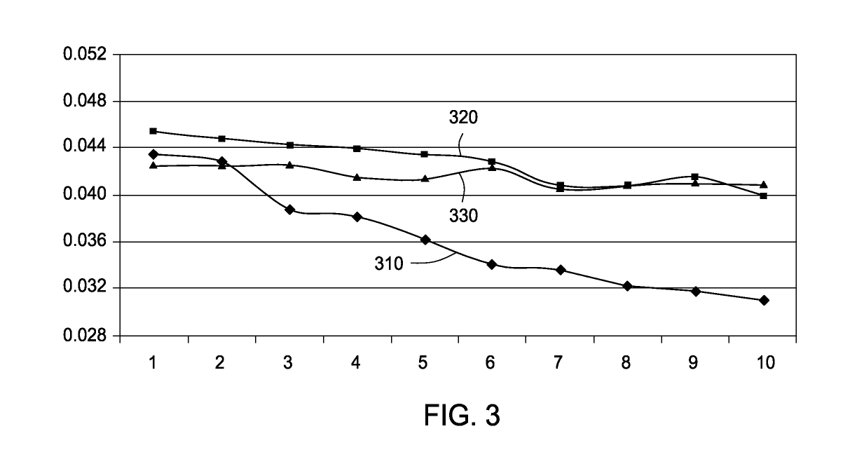

FIG. 3 depicts a graphical representation of a measured formaldehyde concentration emitted from a single sample that was measured ten times in each of three separate sets of measurements, namely, set 310, set 320, and set 330. Prior to measuring each set of sample measurements 310, 320, and 330 the electrochemical sensor was calibrated against a reference sample that emitted a known amount of formaldehyde as in Example I. The sample was prepared as described above in Example 1. To simulate the measurement of a series of different production samples, after each measurement of the sample, the sample was removed from the sample chamber for about 1 minute and then placed back in the sample chamber. As such, the sample chamber was opened and the sample was removed and replaced to simulate an actual series of measurements that would occur if different samples had been measured.

As shown in the graph of FIG. 3, the first set of measurements 310 of the sample shows a much larger rate of decrease in the formaldehyde concentration as compared to the second set of measurements 320 and the third set of measurements 330. After the first set of measurements 310 was measured the electrochemical sensor was recalibrated and then the second set of measurements 320 was conducted. After the second set of measurements 320 was measured the electrochemical sensor was again recalibrated and the third set of measurements 330 was conducted.

As shown in the graph of FIG. 3, for the first set of samples 310 the measured formaldehyde emission from the first measurement of the sample was about 0.043 ppm, but by the time the first sample was measured again at the end of the run as the last sample, the measured formaldehyde concentration dropped down to about 0.31. The rate of decrease in measured formaldehyde for the samples across the second two measurement sets 320, 330 significantly decreased.

As such, depending on when a particular product or sample is measured, e.g., with the first ten measurements after initial calibration or within the second or third set of ten measurements, the electrochemical sensor drift may or may not require correction according to the methods discussed and described herein. If, for example, the composite products have a formaldehyde emission greater than about 1 ppm or 2 ppm, correction of the second and third sets of samples may not be required because the reduced drift in the measured values may not cause the incorrect measured readings to be significant in terms of whether or not a measured sample meets a desired target value. In other words, the determination as to whether or not the drift in the formaldehyde sensor should be accounted for can be based on a number of factors, one of which can be the targeted level of formaldehyde emission. The lower the target level of formaldehyde emission, the more likely correction of the electrochemical sensor drift can be beneficial or required to provide useful formaldehyde emission data.

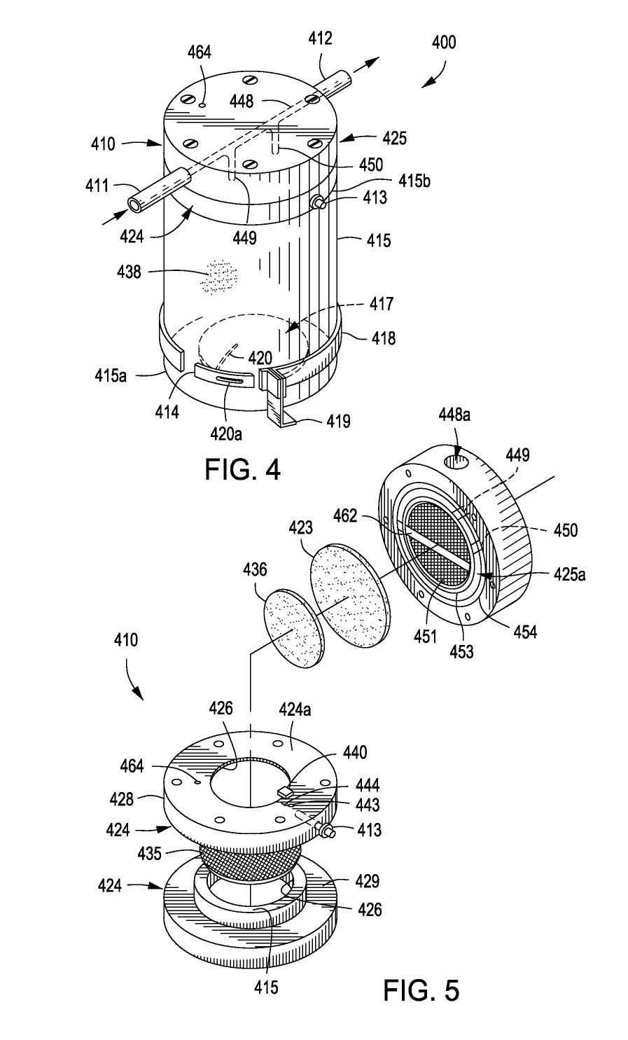

Returning to the Dynamic Micro-Chamber and electrochemical sensor, FIGS. 4 and 5 depict an illustrative electrochemical sensor 400 and an exploded view of an illustrative sensing cell 410, according to one or more embodiments. The electrochemical sensor 400 can include the electrochemical sensing cell 410. The electrochemical sensing cell 410 can detect and measure a concentration of formaldehyde in a sample of circulating air or other gas from a sample chamber (not shown) containing one or more samples. The gas sample, e.g., air, that can include emitted formaldehyde can flow into the sensing cell 410 via conduit 411 and exit from the sensing cell 410 via conduit 412. A pump (not shown) of either the positive pressure or suction type can be used to force or otherwise urge the contained gas sample through the sensing cell 410. If formaldehyde is present in the gas sample, a current can be generated between a sensing electrode terminal 413 and a counterelectrode terminal 414. The current can be amplified and/or combined with other information concerning the one or more samples to drive a meter or other form of display means which can indicate the formaldehyde concentration, for example, in parts per million.

The sensing cell 410 can also include a cylindrical container or vessel 415, closed at a first end thereof 415a, that holds immobilized electrolyte 416 and a counter electrode 417 immersed in the electrolyte. A clamp 418 can at least partially surround the container 415 and serve one or more functions. For example, the clamp 418 can secure the sensing cell 410 to an L-bracket 419. The clamp 418 can be made of metal or other electrically conductive material to provide an electrical connection to the counterelectrode terminal 414. The counterelectrode terminal 414 can be or include a thin strip of foil or other electrically conductive material mounted on the outside of the cylindrical container 415.

One or more wires (one is shown 420) can be connected to the counterelectrode 417. The wire 420 can extend through a hole in the cylindrical container 415. An end portion 420a of the wire 420 can be bent back underneath the counterelectrode terminal 414. The clamp 418 can at least partially cover the counterelectrode terminal 414. The clamp 418 can ensure an electrical contact between the wire 420, the counterelectrode terminal 414, and the clamp 418.

A sensing electrode 423 can be clamped between a cover 424 that seats on an open or second end 415b of the cylindrical container 415 and a manifold cap 425 to which the inlet and outlet conduits 411, 412 can be connected. The cover 424 can define a central opening 426 through which the electrolyte 416 can be in fluid communication with the sensing electrode 423. A surface 425a of the cap 425 can include a recess through which the gas to be analyzed can flow to reach the sensing electrode 423. The cap 425 can include one or more O-rings (two are shown 453, 454) located in respective concentric grooves (not shown) formed in the lower surface 425a of the cap 425. When the cap 425 is clamped to the cover 424, the O-ring 453 can provide a seal that prevents leakage of the gas being analyzed from the recess in the surface 425a of the cap 425 past the interface between the cap 425 and the sensing electrode 423.

An electrical connection to the sensing electrode 23 can be made using suitable electrical connector, e.g., a wire (not shown) that can extend from the electrode terminal 413 to a conductive pad 440 situated on the upper surface 424a of the cover 424. For example, the electrode terminal 413 can be mounted in a lateral bore (not shown) in a retainer 428 of the cover. The wire can pass through a hole (not shown) that extends from the lateral bore to bottom surface of the retainer cover 428. From there the wire can extend along an interface between the retainer cover 428 and a plug 429, and upwardly through a hole 443 to surface 424a of the retainer cover. The wire can run along the surface 24a beneath the conductive pad 440 and back into a second hole 444 in the retainer cover 428. The sensing electrode 423 can be clamped between the retainer cover 428 and the cap 425, and the conductive pad 440 can be clamped between the electrode 423 and the section of wire that extends along the cover surface 424a between the holes 443 and 444. As such, voltametric sensing can be facilitated, since the sensing electrode 423 can be in contact with both the cell electrolyte 416 via the opening 426 and the gas species supplied via the recess 425a. An adhesive (not shown) can be used to bond the plug 429 to the retainer cover 428 so that the cover 424 becomes a unitary element. The cover 424 can also be bonded directly to the container 15.

A screen 435 can support one or more discs 436 of filter material which can help ensure intimate contact between the electrolyte 416 and the sensing electrode 423. The screen 435 can be formed of a material that is non-reactive with the electrolyte 416 and be sufficiently rigid to support the filter disc 436, preferably without becoming concave at its center. A suitable material the screen 435 can be made from can include, but is not limited to, polyester.

The disc 436 can have a diameter slightly less than the opening 426 so as to fit within the opening 426. The disc 436 can be or include a glass filter paper such as that sold commercially. More than one disc 436 can be required to completely fill the space between the screen 435 and the sensing electrode 423. The electrolyte 416 can flow through the screen 435 and wet the disc or discs 436. Since the disc(s) 436 can be slightly compressed between the screen 435 and the sensing electrode 423, intimate contact can be obtained between the electrolyte 416 that wets the disc 436 and the sensing electrode 423.

A disc-shaped screen 451 can be provided within the recess 425a. The screen 451 can provide a pressure on the opposite side of the sensing electrode 423 from the discs 436. As such, when the cap 425 is tightened onto the cover 424, the pressure from the discs 436 can be counteracted by the pressure from the screen 451. The screen 451 can reduce or prevent disc 436 from becoming distorted into a convex shape in which a portion of the sensing electrode 423 could touch the bottom of the recess 425a. The screen 451 can be made from a polyester or other material that is non-reactive with either the sensing electrode 423 material or the gas being analyzed.

To prevent or reduce the likelihood of the electrolyte 416 sloshing within the cell 410, the container 415 can be filled with an inert, absorbent material 438, such as glass wool, to immobilize the electrolyte. A reduction or absence of free electrolyte 416 can reduce or eliminate undesirable sensor noise and can be particularly advantageous when high amplifier gain may be required for low concentration readings.

A small portion of the gas circulating through the sample chamber can be measured or analyzed via the sensing electrode 423. A through passageway 448 can be provided in the cap 425 between the inlet conduit 411 and the outlet conduit 412. A pair of lateral ports 449, 450 can branch off from the passageway 448 and extend to the recess in cap 425 mentioned above. Ports 449 and 450 can be spaced apart so as to be adjacent the edges across the recess. With such placement, some of the gas entrant through the conduit 411 can flow through port 449, into the recess and then out through port 450 and the outlet conduit 412. As such, contact between the sample gas and the counterelectrode 423 can be accomplished within the recess.

One or more holes 464 can be disposed through the cap 425 and the cover 424. The holes 464 can be aligned with one another. With this arrangement, vapor from the electrolyte 416 can be vented from the sensing cell 410.

Due to the very low (essentially undetectable) formaldehyde losses encountered with the operation of the electrochemical sensor 423, the sample chamber can be have a volume of about 0.5 m³ or less, yet still can be used to determine equilibrium formaldehyde emission without introducing sampling error into the determination of the equilibrium formaldehyde emission. A smaller sample chamber in combination with a large emitting surface area (i.e., a high sample loading area by using multiple samples) can come to equilibrium quickly (e.g. in less than about 30 to 60 minutes) and also provide a practical means for monitoring steady state formaldehyde emission rates.

The high sample loading can also increase the obtention rate of steady state conditions, so that the data needed to assess fully the mass transfer characteristics of a board sample can be gathered in a very short time period. As such, the sample chamber size for most quality monitoring methods can be less than about 0.5 m³, and preferably less than about 0.1 m³. In order to obtain formaldehyde emission results which are representative of a full sized (e.g., 1.22 m×2.44 m) sheet of a wood product, it can be preferred that the sample chamber have a volume of at least about 0.02 m³ and can be configured to hold at least three samples, from each sheet.

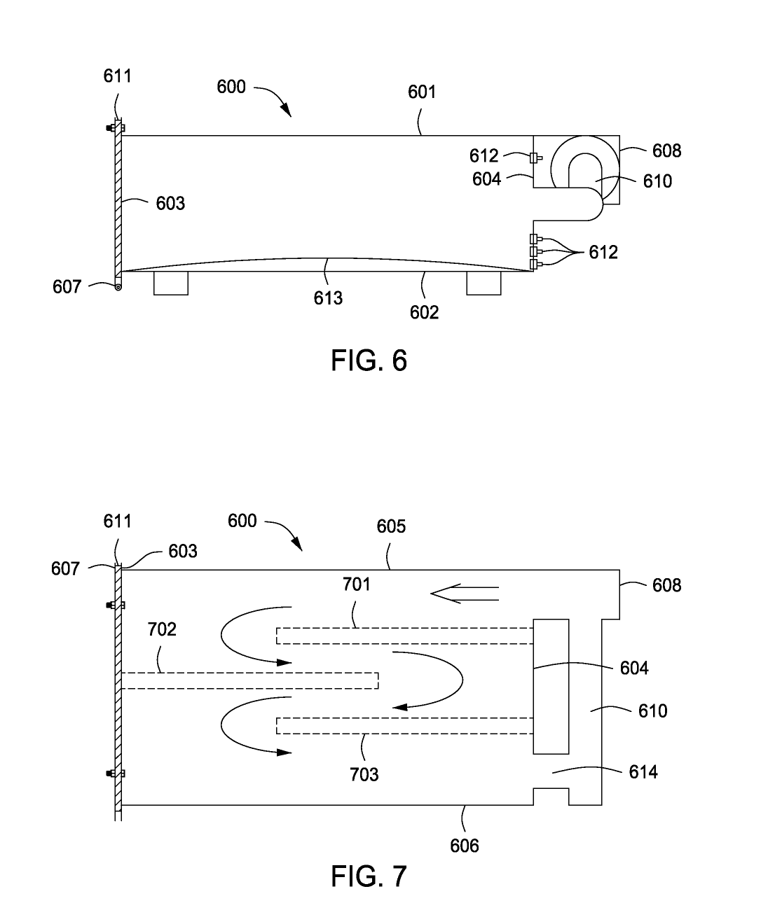

A particularly useful sample chamber can have a volume of about 0.044 m³. With such small chamber sizes, it can be convenient to use samples having a planar surface area of about 0.45 m² to about 0.65 m² although the specific sample size chosen can depend, at least in part, on the actual chamber size used and the particular material or sample being tested. With boards expected to have relatively low mass transfer coefficients, one could use slightly larger board samples than those used with boards having relatively high mass transfer coefficients to keep the time periods similarly short needed to reach steady state and equilibrium conditions. Because sample chamber 600 (discussed below and shown in FIGS. 6 and 7) can place the sample boards in a serpentine path, the chamber can easily accommodate a variety of sample sizes, merely by changing the length of the samples, although the same sample size should be used for any given test.

FIGS. 6 and 7 depict a side and top view, respectively, of an illustrative sample chamber 600, according to one or more embodiments. FIG. 7 depicts the placement of sample boards (three are shown 701, 702, and 703) in the chamber 600. The sample boards can be cut from the same product, e.g., a solid wood board, plywood, oriented strand board, particle board, or any other type of composite sample to be measured. The sample chamber 600 can be a rectangular box having first or “top” wall 601, a second or “bottom” wall 602, a third or “front” wall 603, a fourth or “rear” wall 604, and a fifth and sixth or “side” walls 605 and 606. A door 607 can be located on front wall 603 and gas blower 608 with a recycle conduit 610 can be located on the rear wall 604. The chamber 600 can have widely varying dimensions. One preferred configuration of the chamber 600 can provide for a chamber 600 having a width of about 35 cm, a length of about 60.6 cm, and height of about 20.3 cm. Other suitable configurations of the sample chamber 600 can provide a sample chamber having a cylindrical inner surface such as a pipe or other conduit, for example.

In combination with the arrangement of samples 701, 702, and 703 in chamber 600, the blower 608 can be of a sufficient size to circulate the gas within sample chamber 600 with sufficient velocity to ensure that eddy diffusion across the surfaces of the sample boards 701, 702, 703 is the principal mass transfer mechanism and to help ensure the absence of formaldehyde gradients within chamber 600. For example, the blower can be capable of recirculating gas at a flow rate of about 1,100 L/min to about 1,500 L/min should be sufficient. In another example, the blower can be capable of recirculating gas at a flow rate of about 0.01 L/min to about 1,500 L/min, about 0.01 L/min to about 20 L/min, about 1 L/min to about 600 L/min, or about 5 L/min to about 30 L/min.

The door 607 can be hinged to the sample chamber 600. The door 607 can be sealed to reduce or prevent gas from leaking into or out of chamber 600. Any type or combination of sealing means capable of maintaining an gas tight seal around the perimeter of door 607 can be used. For example, the sealing means can be a closed cell foam 611 of the type commonly used for weather stripping around doors and windows and a pair of wing nuts. Other door sealing means can include, but are not limited to, magnetic seals, hemispherical silicone strips, tongue-and-groove door construction details, and virtually any material useful for weather stripping.

For sampling purposes, for inflow of make-up gas, for exhaust, and for bypass, sample chamber 600 can include one or more ports 612 (three are shown) in rear wall 604 or side wall 606, for example. The port(s) 612 can be positioned where gas input or exhaust will not disrupt the gas flow over the sample boards. The port(s) 612 can be designed so that they can be selectively used in conjunction with the operation of chamber 600.

Referring to FIG. 7, the chamber 600 is shown as containing three sample boards 701, 702, and 703 vertically. The port(s) 612 (not shown) can be located above the recycle conduit 610. The number of sample boards generally used is a matter of choice, but as may be appreciated, the sample chamber 600 must contain at least one board. However, in order to provide the desired range of sample loadings in a conveniently sized sample chamber, the use of three board samples has been found suitable. Three boards reach steady state and equilibrium conditions much faster than a single board. Additionally, the use of three sample boards can facilitate the realization of adequate mass transfer conditions in sample chamber 600. The boards can be arranged so that gas circulating over the boards follows a serpentine path between the outer face of the first board 701 and side wall 605, between the first board 701 and the second board 702, between the second board 702 and the third board 703, and finally between the outer face of the third board 703 and side wall 606. The sampling ports can be located on the rear wall 604 above and below opening 614 for recycle conduit 610 and in the path between the outer face of the third board and right wall 606. Preferably the boards can be evenly spaced in chamber 600 to provide a uniform flow condition in the sample chamber 600.

As discussed above, the edges of the sample boards, and particularly the edges of composite samples such as particleboard and MDF, generally have a much higher formaldehyde diffusion (emission) rate than the planar surfaces of the such a sample. As such, to obtain an accurate measurement of the formaldehyde emission of the samples 701, 702, 703 from which the samples were obtained, the edges of the samples can be sealed to prevent or retard formaldehyde emission during testing to avoid bias. Suitable sealing materials preferably include nonporous tapes and possibly non-volatile liquid sealants. For example, aluminum tape can be sued to seal the edges of samples.

The samples 701, 702, 703 can be positioned in the sample chamber 600 in such a way as to prevent gas leaking and short circuiting directly from inlet to outlet. This can be accomplished, for example, by sealing the boards against the top and bottom walls of the sample chamber 600 to force the gas to follow the desired serpentine flow path through the sample chamber 600. The top and bottom edges of the sample boards can be considered sealed if they are wedged between top 601 and bottom 602. Wedged fits are an efficient form of friction fit that place stress on sample chamber 600 and require sample pieces that are accurately cut. An alternative friction fit can be accomplished more easily using a bent or curved plate 613 (see FIG. 6) disposed within the chamber 600 over bottom wall 602. The plate 613 can be made of a material that does not absorb or react with formaldehyde and can be able to withstand repeated flexure without permanent deformation. Particularly preferred materials include metals such as stainless spring steel.

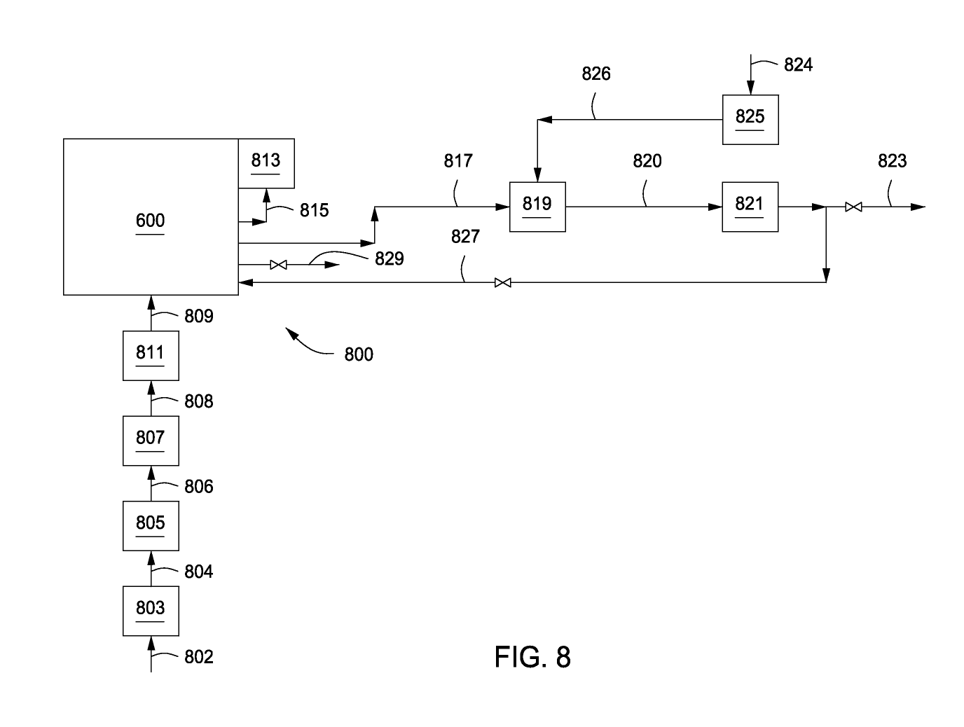

FIG. 8 depicts an illustrative formaldehyde measurement system 800, according to one or more embodiments. When measuring steady-state formaldehyde emissions (Cₛ), a make-up gas pump 803 can introduce, direct, or otherwise supply ambient make-up gas supplied via line 802 to a gas regulator 805 via line 804. The gas from the gas regulator 805 can be introduced via line 806 to one or more activated carbon filters 807. The gas from the carbon filter 807 can be introduced via line 808 to a flow meter 811. From the flow meter 811 the gas can be introduced via line 809 into the sample chamber 600. The carbon filter 807 can be designed to remove contaminants, e.g., formaldehyde present in the surrounding environment, which could interfere with proper measurement of formaldehyde emission levels in the sample chamber 600. Flow meter 811 can display and allow control over the rate of make-up gas introduced into sample chamber 600 through the conduit 809. Any suitable flow meter controller can be used with the measurement system 800, which permits adjustment of the make-up gas flow between 0 and that level needed to yield the appropriate ratio of make-up gas flow to sample area (Q/A) equivalent to the regulatory testing protocol of ASTM E1333-10, i.e., 1.9 m³/m²-hr for medium density fiberboard, 1.17 m³/m²-hr for particleboard, and 0.53 m³/m²-hr for hardwood plywood. One exemplary flowmeter is available from Cole-Parmer Instrument Co., Chicago, Ill. as model number EW-03227-30. Make-up gas is not used when measuring equilibrium formaldehyde emission values.

The blower 813 can recirculate the formaldehyde-containing gas in the sample chamber 600 via recycle conduit 815 so as to ensure adequate mixing within the sample chamber 600. Sampling line or conduit 817 can be used to remove a portion of the circulating gas selectively during a sampling phase through timer and 2-way valve assembly 819, which can be introduced via line 820 to the electrochemical sensor 821 containing an integral sample pump. The portion of circulating gas selectively delivered to the electrochemical sensor 821 can be discharged via an exhaust line 823. Alternately, ambient air via line 824 can be directed into the electrochemical sensor 821 through a zero reference filter 825 and via line 826 to the 2-way valve 819 and line 820. The ambient air introduced via line 824 can be discharged via the exhaust line 823.

During operation of the sensor unit, gas, such as ambient air or chamber gas, can flow through the formaldehyde sensor. Proper zeroing of the sensor output can be done when filtered gas flows through the electrochemical sensor 821. Bypass line 827, which can be selectively connected to the exhaust line 823, such as by a valve, can be used to route the circulated gas sample directly from electrochemical sensor 821 back to chamber 600. This arrangement can be used when measuring an equilibrium formaldehyde emission value.

Gas can be exhausted from the sample chamber 600 through one or more valved exhaust ports via line 829. The discharge ends of exhaust line 829, and exhaust line 823 of the electrochemical sensor 821, can be positioned a sufficient distance from make-up gas pumps so as not to introduce excessive ambient formaldehyde through filters 807 and 825. Preferably, the exhaust lines can discharge into a room separate from the location of chamber 600 or outside.

The measurement system 800 can be operated in two modes. In a first mode, steady state formaldehyde emission values for a sample can be determined at any desired make-up gas loading. In a second mode, an equilibrium emission value for the samples can be measured. In both modes of operation, the samples can be placed in the sample chamber 600 and blower 608 can be activated. When measuring a steady state emission, make-up gas pump 803 can also be activated and the flow meter 811 can be adjusted to provide the proper flow rate of make-up gas through feed conduit 809 into chamber 600 to provide the Q/A ratio appropriate for the sample being tested. A portion of the recirculating gas can be exhausted through exhaust conduit 829 so as to maintain a proper mass balance. When a formaldehyde measurement of the recirculating gas is taken by flow of a portion of the recirculating gas through conduit 817, it can subsequently be exhausted through exhaust conduit 823. Thus, in the steady state mode, recirculating gas can be discharged through port 829, and gas flowed to sensor 821 can be discharged through port 823. When an equilibrium emission is being measured, exhaust ports 829 and 823 can be closed, make-up gas flow into chamber 600 through feed conduit 809 can be terminated, and gas flow to the electrochemical sensor 821 through conduit 817 can be returned to the sample chamber through bypass conduit 827. The system thus becomes close-ended.

Instead of having three separate valve-controlled conduits 827, 829, and 823, the measurement system 800 can be operated manually with only exhaust conduits 829 and 823, which in the equilibrium mode, can be placed in flow communication to establish return line 827.

It has been observed that the electrochemical sensor 821 used in the measurement system 800 has such reproducible response characteristics that it is not necessary, when measuring the formaldehyde emission of a board sample, to wait until the output of the sensor stabilizes. Rather, the sensor can be calibrated using a sample with a known formaldehyde concentration by tuning the output to the known value at any time after the initial response reaches about 80 to 90% of the known final output. This has been confirmed by calibrating the sensor to a known sample at various response times from 2 minutes to 20 minutes with no statistical difference in the subsequent results obtained.

Operation of the device for measuring formaldehyde emission can start with a calibration of the electrochemical sensor such as against a sample whose emission characteristics previously have been determined such as by using the large scale chamber, and/or by using the small test chamber in combination with a conventional liquid absorption, i.e., impinger, test, and/or by using convention wet chemistry techniques. In a preferred calibration technique, the known samples can be inserted into chamber 600, blower 610 can be activated, and the make-up gas flow rate appropriate for the sample being analyzed can be initiated. During a time period sufficient for the known samples to reach steady state conditions, e.g., less than about 30 minutes or less than about 20 minutes or less than about 10 minutes or less than about 5 minutes, a two-way valve 819 can direct gas from zero reference filter 825 into the electrochemical sensor 821.

Once a sufficient time has elapsed for the samples having the known emission characteristics to reach steady state emission, the sensor can be exposed to the formaldehyde source of the known concentration. This can be done by setting the timer for the two-way valve for the appropriate exposure period, generally between 2 and 20 minutes. A portion of the gas from chamber 600 can flow through conduit 817 and into the electrochemical sensor 821. The flow rate of the sampled gas can be adjusted to between about 0.3 L/min to 0.7 L/min, e.g., about 0.5 L/min. If the flow rate to the sensor is too low, then the sensor response time can be adversely affected, and an accurate reading cannot be obtained in the desired minimum time frame. If the flow rate is too high then the lifetime of the sensor can be adversely affected. Furthermore, a flow rate that is too high can be undesirable when measuring the equilibrium formaldehyde emission of a board sample. Under proper flow conditions, a sensor can be expected to last for about 300-600 hours of testing.

The instrumentally displayed sensor output can be tuned to the known formaldehyde emission value of the sample through span adjustment at the desired time after exposure of the sensor to the known formaldehyde source, typically about five minutes. All subsequent determinations of the steady state or equilibrium formaldehyde emission, i.e., concentration, of unknown samples can then conducted at the same time interval after exposure as used for the initial calibration, e.g., about 5 minutes after exposure. Such calibrations are well within the existing skill for one in this art and are outlined in the protocol for the ASTM E1333-10 test.

In an alternative calibration technique, unknown samples can be used first, the above-described procedure can be repeated three times to get an average emission value for the unknown sample at the existing setting. Then, the protocol can be repeated again, but instead of determining formaldehyde concentration using the electrochemical sensor, the exhaust from the small chamber can be routed through a meter and into a liquid impinger for measuring formaldehyde by a wet chemistry technique. The previously measured values facilitate the wet chemistry analysis. According to the ASTM E1333-10 procedure, a thirty minute period for absorbing formaldehyde in the liquid impinger should be suitable. The samples then can be rerun as above using the electrochemical sensor. The emission value obtained from the wet chemistry procedure can be used as the standard for adjusting the span on the sensor output upon rerunning the board samples a fourth time.

Once calibrated, samples of unknown emission characteristics can be loaded in the sample chamber, and the gas flow rates for the makeup gas (if used) and sampling pump can be adjusted as desired. Any number of samples can be used, but it can be preferred to use a manageable number, such as 3. An odd number of samples can also be preferred so that a serpentine flow around the samples can be preserved. For a sample size of three samples having the dimensions of about 20 cm by about 38 cm, a sampling pump flow rate of about 0.5 L/min in a sampling chamber of about 0.044 m³ can be used. Make-up gas can be supplied at rates of up to about 15 L/min depending on the samples being tested.

Prior to testing, samples can be stored in hermetically sealed bags to arrest formaldehyde emission, and just prior to testing the samples are preferably conditioned for about an hour. The samples can be conditioned under fixed conditions of temperature and ventilation. A conditioning temperature of about 25° C. has proved suitable for producing results comparable with results obtained with ASTM E1333-10. The sample conditioning and testing conditions can be carried out at a temperature ranging from a low of about 19.5° C., about 21° C., or about 23° C. to a high of about 27° C., about 29° C., or about 30.5° C. and at a relative humidity ranging from a low of about 40%, about 43%, about 45%, or about 48% to a high of about 52%, about 55%, about 57%, or about 60%. The background formaldehyde, i.e., the formaldehyde present in the environment surrounding the sample chamber and the gas that can be directed into the sample chamber, can have background formaldehyde concentration of less than about 0.1 ppm, less than about 0.07 ppm, less than about 0.05 ppm, less than about 0.03 ppm, or less than about 0.01 ppm, as measured according to the 60 minute gas test using an impinger, as discussed and described in ASTM E1333-10 and ASTM D6007-02 (2008).

Once the samples have reached steady state in the sample chamber, which requires less than about 30 minutes, e.g., the samples have been in the sample chamber with the appropriate flow rates for about 5-10 minutes, with gas flow through the zero reference filter into the sensor, thereafter the time on the 1-way solenoid valve can be set to allow gas flow from the sample chamber 600 and into the electrochemical sensor for about 5 minutes before returning to gas flow through the zero reference filter. Readings can be taken at intervals of 2, 4, and 5 minutes. At the end of the 5 minute-interval, the 2-way valve can automatically return gas flow through the zero reference filter. The recorded emission value can be the reading taken at about 5 minutes. The reading sequence can be repeated twice with different samples from the same sample to ensure accuracy of the measurement.

The measured formaldehyde concentration values of the unknown samples can then be corrected according to the methods discussed and described above or elsewhere herein. Once the corrected values are acquired, those formaldehyde emission values can be corrected for 25° C. and 50% relative humidity. Such corrections are within the existing skill level for one in this art from the above mentioned protocol for the ASTM E1333-10 test procedure. For example, the temperature and humidity corrections can be made using the well known Berge et al. formula. The measurement system 800 can be automated through appropriate hardware integrated with appropriate software and computer system. The basic operations, however, remain as described above.

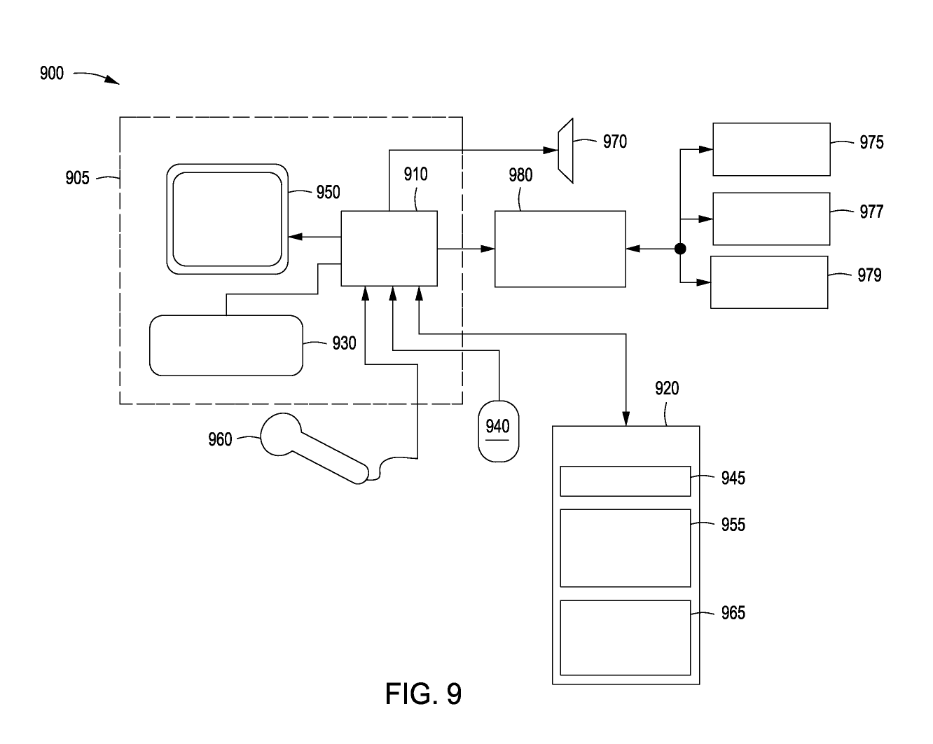

FIG. 9 depicts a representative computer system that can be used to correct one or more formaldehyde emission measurements, according to one or more embodiments. Those skilled in the art will understand that there are many computer system configurations and variations, and it should be understood that the computer system 900 presented in FIG. 9 is not meant to limit the configurations within which the many embodiments, as described herein, can be employed. The voltage measurements provided via the electrochemical sensor 400 and/or an amplifier (not shown) coupled to the electrochemical sensor 400 can be input into the computer system 900 with the computer system determining the correct formaldehyde emission values for one or more measured samples.

The computer system 900 can include a computer 905, which can include a central processing unit 910, an input device or keyboard 930, and a monitor 950 on which a software package according to one or more embodiments described herein can be executed. The computer 905 can also include a memory 920 as well as additional input and output devices, for example a mouse 940, a microphone 960, and/or a speaker 970. The mouse 940, the microphone 960, and the speaker 970 can be used for, among other purposes, universal access and voice recognition or commanding. The monitor 950 can be touch-sensitive to operate as an input device as well as a display device.

The computer 905 can interface with database 977, support computer or processor 975, other databases and/or other processors 979, or the Internet via the interface 980. It should be understood that the term “interface” does not indicate a limitation to interfaces that use only Ethernet connections and refers to all possible external interfaces, wired or wireless. It should also be understood that database 977, processor 975, and/or other databases and/or other processors 979 are not limited to interfacing with computer 905 using network interface 980 and can interface with computer 905 in any means sufficient to create a communications path between the computer 905 and database 977, processor 975, and/or other databases and/or other processors 979. For example, in one or more embodiments, database 977 can interface with computer 905 via a USB interface while processor 975 can interface via some other high-speed data bus without using the network interface 980. In one or more embodiments, the computer 905, processor 975, and other processors 979 can be configured as part of a multiprocessor distributed system.

It should be understood that even though the computer 905 is shown as a platform on which the methods described can be performed, the methods described could be performed on any platform. For example, the many and varied embodiments described herein can be used on any device that has computing capability. For example, the computing capability can include the capability to access any communications bus protocols such that the user can interact with the many and varied computers 905, processors 975, and/or other databases and processors 979 that can be distributed or otherwise assembled. These devices can include, but are not limited to: supercomputers, arrayed server networks, arrayed memory networks, arrayed computer networks, distributed server networks, distributed memory networks, distributed computer networks, desktop personal computers (PCs), tablet PCs, hand held PCs, laptops, devices sold under the trademark names BLACKBERRY™ or PALM™, cellular phones, hand held music players, or any other device or system having computing capabilities.

Programs can be stored in the memory 920 and the central processing unit 910 can work in concert with at least the memory 920, the input device 930, and/or the output device 950 to perform tasks for the user. In one or more embodiments, the memory 920 includes any number and combination of memory devices, without limitation, as is currently available or can become available in the art. In one or more embodiments, memory devices can include without limitation, and for illustrative purposes only: database 977, other databases and/or processors 979, hard drives, disk drives, random access memory, read only memory, electronically erasable programmable read only memory, flash memory, thumb drive memory, and any other memory device. Those skilled in the art are familiar with the many variations that can be employed using memory devices and no limitations should be imposed on the embodiments herein due to memory device configurations and/or algorithm prosecution techniques.

The memory 920 can store an operating system (OS) 945, a formaldehyde emission correction agent 955, and/or other systems or agents 965. The operating system 945 can facilitate control and execution of software using the CPU 910. Any available operating system can be used in this manner including WINDOWS®, LINUX®, UNIX®, and the like.

In one or more embodiments, the CPU 910 can execute either from a user request or automatically. In one or more embodiments, the CPU 910 can execute the formaldehyde emission correction agent 955 when a user requests, among other requests, to determine a corrected formaldehyde emission value for one or more measured samples. For example, in carrying out the formaldehyde emission correction according to the first method discussed and described above, the formaldehyde emission correction agent 955 can analyze data provided via the electrochemical sensor 400 and generate a linear regression trend-line and formula using the concentration of the formaldehyde measured by the electrochemical sensor and the time at which the measurement was taken for the two measurements of the first sample. From the linear regression trend line, the correction factors for each measured production sample can be determined and the corrected formaldehyde emission values for each production sample can thus be determined.

In one or more embodiments, the formaldehyde emission correction agent 955 can be a formaldehyde emission correction agent software package. In one or more embodiments, the CPU 910 can execute the formaldehyde emission correction agent software package when a user requests, among other requests, to determine a corrected formaldehyde emission value for one or more samples measured via the electrochemical sensor 400. It should be noted that the formaldehyde emission correction agent 955 can be fully autonomous code sets, partially integrated code sets, or fully integrated code sets and no limitations should be construed from the depiction of the formaldehyde emission correction agent 955 as separate agents.

Embodiments of the present disclosure further relate to any one or more of the following paragraphs:

1. A method for measuring formaldehyde emissions from a plurality of samples, comprising: calibrating an electrochemical sensor using a reference sample to provide a calibrated electrochemical sensor, wherein the time of calibration is equal to time zero; placing a plurality of samples within a sample chamber one at a time and measuring a formaldehyde concentration of a gas passed across one or more surfaces of each sample, wherein the first sample measured is measured again as the last sample; generating a linear regression trend-line based on the two formaldehyde concentrations measured from the first sample; generating a revised linear regression trend-line based on what the formaldehyde concentration of the first sample would be at time zero and the formaldehyde concentration of the first sample when re-measured as the last sample; generating a correction factor for at least one of the plurality of samples measured between the two measurements of the first sample; and multiplying the measured formaldehyde emission for the at least one of the plurality of samples measured between the two measurements of the first sample by its correction factor to provide a corrected formaldehyde concentration for the at least one of the plurality of samples.

2. The method according to paragraph 1, wherein the plurality of samples are conditioned for at least two hours prior to placement within the sample chamber, wherein the conditioning of the samples comprises flowing gas at a velocity of about 45 m/minute or more over one or more surfaces of the samples.

3. The method according to paragraph 1 or 2, wherein the plurality of samples are measured at a temperature ranging from about 19.5° C. to about 30.5° C.

4. The method according to any one of paragraphs 1 to 3, wherein the relative humidity within the sample chamber ranges from about 40% to about 60% when the formaldehyde concentration of the plurality of samples is measured.

5. The method according to any one of paragraphs 1 to 4, wherein the plurality of samples are selected from the group consisting of: particleboard, medium density fiberboard, high density fiberboard, oriented strand board, plywood, laminated veneer lumber, fiberglass mats, and fiberglass insulation.

6. The method according to any one of paragraphs 1 to 5, wherein each sample of the plurality of samples are the same type of sample with respect to one another.

7. The method according to any one of paragraphs 1 to 6, wherein at least two samples of the plurality of samples are a different type of sample with respect to one another.

8. The method according to any one of paragraphs 1 to 7, wherein the gas passed across the one or more surfaces of each sample is air.

9. The method according to any one of paragraphs 1 to 8, wherein the gas passed across the one or more surfaces of each sample is air, and wherein the air, prior to passing across the one or more surfaces of each sample, has a formaldehyde concentration of less than about 0.1 ppm.

10. A method for measuring formaldehyde emissions from a plurality of samples, comprising: calibrating an electrochemical sensor using a reference sample to provide a calibrated electrochemical sensor, wherein the time of calibration is equal to time zero; placing a plurality of wood based samples within a sample chamber one at a time and measuring a formaldehyde concentration of a gas passed across one or more surfaces of each wood based sample, wherein the first wood based sample measured is measured again as the last sample, and wherein measuring the formaldehyde concentration of each sample comprises: flowing the gas through the sample chamber when each wood based sample is located therein to produce the formaldehyde containing gas; contacting at least a portion of the formaldehyde containing gas with a sensing electrode of the electrochemical sensor; and detecting a current generated by the sensing electrode when in contact with the formaldehyde containing gas, wherein the detected current is correlated to a formaldehyde concentration; generating a linear regression trend-line, wherein the linear regression trend-line is based on at least two points, wherein the first point is equal to the formaldehyde concentration of the first wood based sample measured after calibration of the electrochemical sensor, and wherein the second point is equal to the formaldehyde concentration of the first wood based sample when measured again as the last sample; determining a formaldehyde emission for the first wood based sample at time equal to time zero; generating a revised linear regression trend-line based on at least two points, wherein the first point is equal to the formaldehyde concentration of the first wood based sample at time zero and the second point is equal to the formaldehyde concentration of the first wood based sample when measured again as the last sample; determining a correction factor for at least one of the plurality of wood based samples, wherein the correction factor for the at least one of the plurality of wood based samples is equal to the formaldehyde concentration of the first wood based sample at time zero divided by what the concentration of the first wood based sample would be at the time the at least one of the plurality of wood based samples was measured; and multiplying the measured formaldehyde concentration of the at least one of the plurality of wood based samples by its correction factor to provide a corrected formaldehyde concentration value for the at least one of the plurality of samples.

11. The method according to paragraph 10, wherein the plurality of wood based samples are conditioned for at least two hours prior to placement within the sample chamber, wherein the conditioning of the samples comprises flowing gas at a rate of about 45 m/min or more over one or more surfaces of the wood based samples.

12. The method according to paragraph 10 or 11, wherein the plurality of wood based samples are measured at a temperature ranging from about 19.5° C. to about 30.5° C.

13. The method according to any one of paragraphs 10 to 12, wherein the relative humidity within the sample chamber ranges from about 40% to about 60% when the formaldehyde concentration of the plurality of wood based samples is measured.

14. The method according to any one of paragraphs 10 to 13, wherein the plurality of wood based samples is selected from the group consisting of: particleboard, medium density fiberboard, high density fiberboard, oriented strand board, plywood, and laminated veneer lumber.

15. The method according to any one of paragraphs 10 to 14, wherein each wood based sample of the plurality of wood based samples are the same type of wood based sample with respect to one another.

16. The method according to any one of paragraphs 10 to 15, wherein at least two samples of the plurality of wood based samples are a different type of wood based sample with respect to one another.

17. The method according to any one of paragraphs 10 to 16, wherein the gas passed across the one or more surfaces of each wood based sample comprises air.

18. The method according to any one of paragraphs 10 to 17, wherein the gas passed across the one or more surfaces of each wood based sample comprises air, and wherein the air, prior to passing across the one or more surfaces of each sample, has a formaldehyde concentration of less than about 0.1 ppm.

19. A method for measuring formaldehyde emissions from a plurality of samples made with a formaldehyde containing adhesive, comprising: calibrating an electrochemical sensor using a reference sample to provide a calibrated electrochemical sensor, wherein the time of calibration is equal to time zero, wherein calibrating the electrochemical sensor comprises measuring a formaldehyde concentration of a gas passed across one or more surfaces of the reference sample while within a sample chamber; placing a plurality of samples within the sample chamber one at a time and measuring a formaldehyde concentration of a gas passed across one or more surfaces of each sample, measuring a formaldehyde concentration of a gas passed across the reference sample after measuring the formaldehyde concentration of the plurality of samples; generating a linear regression trend-line based on the two formaldehyde concentrations measured from the reference sample; generating a correction factor for at least one of the plurality of samples measured between the two measurements of the reference sample; and multiplying the measured formaldehyde emission for the at least one of the plurality of samples measured between the two measurements of the reference sample by its correction factor to provide a corrected formaldehyde concentration for the at least one of the plurality of samples.

20. The method according to paragraph 19, wherein the plurality of samples are conditioned for at least two hours prior to placement within the sample chamber, wherein the conditioning of the samples comprises flowing gas at a velocity of about 45 m/minute or more over one or more surfaces of the samples.

21. The method according to paragraph 19 or 20, wherein the plurality of samples are measured at a temperature ranging from about 19.5° C. to about 30.5° C.

22. The method according to any one of paragraphs 19 to 21, wherein the relative humidity within the sample chamber ranges from about 40% to about 60% when the formaldehyde concentration of the plurality of samples is measured.

23. The method according to any one of paragraphs 19 to 22, wherein the plurality of samples are selected from the group consisting of: particleboard, medium density fiberboard, high density fiberboard, oriented strand board, plywood, laminated veneer lumber, fiberglass mats, and fiberglass insulation.

24. The method according to any one of paragraphs 19 to 23, wherein each sample of the plurality of samples are the same type of sample with respect to one another.

25. The method according to any one of paragraphs 19 to 24, wherein at least two samples of the plurality of samples are a different type of sample with respect to one another.

26. The method according to any one of paragraphs 19 to 25, wherein the gas passed across the one or more surfaces of each sample is air.

27. The method according to any one of paragraphs 19 to 26, wherein the gas passed across the one or more surfaces of each sample is air, and wherein the air, prior to passing across the one or more surfaces of each sample, has a formaldehyde concentration of less than about 0.1 ppm.

28. A method for measuring formaldehyde emissions from a plurality of samples that emit formaldehyde therefrom, comprising: calibrating an electrochemical sensor using a reference sample to provide a calibrated electrochemical sensor, wherein the time of calibration is equal to time zero, wherein calibrating the electrochemical sensor comprises measuring a formaldehyde concentration of a gas passed across one or more surfaces of the reference sample while within a sample chamber; placing a plurality of samples within the sample chamber one at a time and measuring a formaldehyde concentration of a gas passed across one or more surfaces of each sample, generating a linear regression trend-line based on two or more of the measured formaldehyde concentrations; generating a correction factor for at least one of the plurality of samples; and multiplying the measured formaldehyde concentration for the at least one of the plurality of samples measured by its correction factor to provide a corrected formaldehyde concentration for the at least one of the plurality of samples.

29. The method according to paragraph 28, wherein the linear regression trend-line is generated based on two or more formaldehyde concentrations measured from the reference sample, the plurality of samples, or a combination thereof.

30. The method according to paragraph 28 or 29, wherein the linear regression trend-line is based on two or more formaldehyde concentrations measured from the plurality of samples.

31. The method according to any one of paragraphs 28 to 30, wherein the linear regression trend-line is based on the formaldehyde concentration of the reference sample and the formaldehyde concentration of one or more of the plurality of samples.

32. The method according to any one of paragraphs 28 to 31, further comprising, measuring a formaldehyde concentration of a gas passed across one or more surfaces of the reference sample after measuring the formaldehyde concentration of the plurality of samples, wherein the linear regression trend-line is based on the two formaldehyde concentrations measured from the reference sample.

33. The method according to any one of paragraphs 28 to 32, wherein the plurality of samples are conditioned for at least two hours prior to placement within the sample chamber, wherein the conditioning of the samples comprises flowing gas at a velocity of about 45 m/minute or more over one or more surfaces of the samples.

34. The method according to any one of paragraphs 28 to 33, wherein the plurality of samples are measured at a temperature ranging from about 19.5° C. to about 30.5° C.

35. The method according to any one of paragraphs 28 to 34, wherein the relative humidity within the sample chamber ranges from about 40% to about 60% when the formaldehyde concentration of the plurality of samples is measured.

36. The method according to any one of paragraphs 28 to 35, wherein the plurality of samples are selected from the group consisting of: particleboard, medium density fiberboard, high density fiberboard, oriented strand board, plywood, laminated veneer lumber, solid wood, fiberglass mats, and fiberglass insulation.

37. The method according to any one of paragraphs 28 to 36, wherein each sample of the plurality of samples are the same type of sample with respect to one another.

38. The method according to any one of paragraphs 28 to 37, wherein at least two samples of the plurality of samples are a different type of sample with respect to one another.

39. The method according to any one of paragraphs 28 to 38, wherein the gas passed across the one or more surfaces of the reference sample and each of the plurality of samples is air.

40. The method according to any one of paragraphs 28 to 39, wherein the gas passed across the one or more surfaces of the reference sample and each of the plurality of samples is air, and wherein the air, prior to passing across the one or more surfaces of each sample, has a formaldehyde concentration of less than about 0.1 ppm.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for measuring formaldehyde emissions from a plurality of samples, comprising:
calibrating an electrochemical sensor using a reference sample to provide a calibrated electrochemical sensor, wherein the time of calibration is equal to time zero;
placing a plurality of samples within a sample chamber one at a time and measuring a formaldehyde concentration of a gas passed across one or more surfaces of each sample, wherein the first sample measured is measured again as the last sample;
generating a linear regression trend-line based on the two formaldehyde concentrations measured from the first sample;
generating a revised linear regression trend-line based on what the formaldehyde concentration of the first sample would be at time zero and the formaldehyde concentration of the first sample when re-measured as the last sample;
generating a correction factor for at least one of the plurality of samples measured between the two measurements of the first sample; and
multiplying the measured formaldehyde emission for the at least one of the plurality of samples measured between the two measurements of the first sample by its correction factor to provide a corrected formaldehyde concentration for the at least one of the plurality of samples.

2. The method of claim 1, wherein the plurality of samples are conditioned for at least two hours prior to placement within the sample chamber, wherein the conditioning of the samples comprises flowing gas at a velocity of about 45 m/minute or more over one or more surfaces of the samples.

3. The method of claim 1, wherein the plurality of samples are measured at a temperature ranging from about 19.5° C. to about 30.5° C.

4. The method of claim 1, wherein the relative humidity within the sample chamber ranges from about 40% to about 60% when the formaldehyde concentration of the plurality of samples is measured.

5. The method of claim 1, wherein the plurality of samples are selected from the group consisting of: particleboard, medium density fiberboard, high density fiberboard, oriented strand board, plywood, laminated veneer lumber, fiberglass mats, and fiberglass insulation.

6. The method of claim 1, wherein each sample of the plurality of samples are the same type of sample with respect to one another.

7. The method of claim 1, wherein at least two samples of the plurality of samples are a different type of sample with respect to one another.

8. The method of claim 1, wherein the gas passed across the one or more surfaces of each sample is air.

9. The method of claim 1, wherein the gas passed across the one or more surfaces of each sample is air, and wherein the air, prior to passing across the one or more surfaces of each sample, has a formaldehyde concentration of less than about 0.1 ppm.

10. A method for measuring formaldehyde emissions from one or more wood samples, comprising:
calibrating an electrochemical sensor using a reference sample to provide a calibrated electrochemical sensor, wherein the time of calibration is equal to time zero;
placing a plurality of wood based samples within a sample chamber one at a time and measuring a formaldehyde concentration of a gas passed across one or more surfaces of each wood based sample, wherein the first wood based sample measured is measured again as the last sample, and wherein measuring the formaldehyde concentration of each sample comprises:
flowing the gas through the sample chamber when each wood based sample is located therein to produce the formaldehyde containing gas;
contacting at least a portion of the formaldehyde containing gas with a sensing electrode of the electrochemical sensor; and
detecting a current generated by the sensing electrode when in contact with the formaldehyde containing gas, wherein the detected current is correlated to a formaldehyde concentration;
generating a linear regression trend-line, wherein the linear regression trend-line is based on at least two points, wherein the first point is equal to the formaldehyde concentration of the first wood based sample measured after calibration of the electrochemical sensor, and wherein the second point is equal to the formaldehyde concentration of the first wood based sample when measured again as the last sample;
determining a formaldehyde emission for the first wood based sample at time equal to time zero;
generating a revised linear regression trend-line based on at least two points, wherein the first point is equal to the formaldehyde concentration of the first wood based sample at time zero and the second point is equal to the formaldehyde concentration of the first wood based sample when measured again as the last sample;
determining a correction factor for at least one of the plurality of wood based samples, wherein the correction factor for the at least one of the plurality of wood based samples is equal to the formaldehyde concentration of the first wood based sample at time zero divided by what the concentration of the first wood based sample would be at the time the at least one of the plurality of wood based samples was measured; and
multiplying the measured formaldehyde concentration of the at least one of the plurality of wood based samples by its correction factor to provide a corrected formaldehyde concentration value for the at least one of the plurality of samples.

11. The method of claim 10, wherein the plurality of wood based samples are conditioned for at least two hours prior to placement within the sample chamber, wherein the conditioning of the samples comprises flowing gas at a rate of about 45 m/min or more over one or more surfaces of the wood based samples.

12. The method of claim 10, wherein the plurality of wood based samples are measured at a temperature ranging from about 19.5° C. to about 30.5° C.

13. The method of claim 10, wherein the relative humidity within the sample chamber ranges from about 40% to about 60% when the formaldehyde concentration of the plurality of wood based samples is measured.

14. The method of claim 10, wherein the plurality of wood based samples is selected from the group consisting of: particleboard, medium density fiberboard, high density fiberboard, oriented strand board, plywood, and laminated veneer lumber.

15. A method for measuring formaldehyde emissions from a plurality of samples that emit formaldehyde therefrom, comprising:
calibrating an electrochemical sensor using a reference sample to provide a calibrated electrochemical sensor, wherein the time of calibration is equal to time zero, wherein calibrating the electrochemical sensor comprises measuring a formaldehyde concentration of a gas passed across one or more surfaces of the reference sample while within a sample chamber;
placing a plurality of samples within the sample chamber one at a time and measuring a formaldehyde concentration of a gas passed across one or more surfaces of each sample;
generating a linear regression trend-line based on two or more of the measured formaldehyde concentrations;
generating a correction factor for at least one of the plurality of samples; and
multiplying the measured formaldehyde concentration for the at least one of the plurality of samples measured by its correction factor to provide a corrected formaldehyde concentration for the at least one of the plurality of samples.

16. The method of claim 15, wherein the linear regression trend-line is generated based on two or more formaldehyde concentrations measured from the reference sample, the plurality of samples, or a combination thereof.

17. The method of claim 15, wherein the linear regression trend-line is based on two or more formaldehyde concentrations measured from the plurality of samples.

18. The method of claim 15, wherein the linear regression trend-line is based on the formaldehyde concentration of the reference sample and the formaldehyde concentration of one or more of the plurality of samples.

19. The method of claim 15, wherein the plurality of samples are selected from the group consisting of: particleboard, medium density fiberboard, high density fiberboard, oriented strand board, plywood, laminated veneer lumber, solid wood, fiberglass mats, and fiberglass insulation.

20. The method of claim 15, wherein each sample of the plurality of samples are the same type of sample with respect to one another.
